(19) United States
(12) Patent Application Publication
(10) Pub. No.: US 2002/0124271 A1
(43) Pub. Date: Sep. 5, 2002

(54) Interactive media terminal

(76) Inventors: R. Scott Herrmann, Issaquah, WA (US); Timothy J. Sherwood, Medina, WA (US); Jim L. Dixon, Seattle, WA (US); Robson B. Grieve, Seattle, WA (US); Tom C. O'Rourke, Seattle, WA (US); William Becker, Bellevue, WA (US); Helene Dahlander, Bainbridge Island, WA (US); Douglas Turner, Seattle, WA (US); Richard Boyer, Monroe, WA (US); Darryl Laferte, Seattle, WA (US)

Correspondence Address: PERKINS COIE LLP, P.O. BOX 2168, MENLO PARK, CA, 94026, US

(21) Appl. No.: 10/066,434

(22) Filed: Jan. 31, 2002

Related U.S. Application Data
(60) Provisional application No. 60/265,644, filed on Jan. 31, 2001.
(60) Provisional application No. 60/340,004, filed on Dec. 7, 2001.

(51) Int. Cl. H04N 7/173; H04N 7/16

(52) U.S. Cl. 725/151; 725/139; 725/131

(57) ABSTRACT

An interactive public media display terminal capable of presenting different presentations to the viewing public simultaneously is presented. The media terminal includes a large vertically orientated display that can be partitioned to display varied content to attract different factions of a viewing audience. The content can be configured to attract viewers based on the distance they are away from the terminal. To accomplish this, the display can be coupled among a computer and a communication device configured to exchange data with a network such as the Internet. The display can also include a touch sensitive screen and other input devices that allow a user to physically interact with the terminal based on the content being presented. Furthermore, the terminal can be configured to gather data regarding the audience that views the content that is displayed.

### CROSS-REFERENCE TO RELATED APPLICATIONS

This application claims the benefit of U.S. Provisional Patent Application No. 60/265,644 filed Jan. 31, 2001 and U.S. Provisional Patent Application No. 60/340,004 filed Dec. 7, 2001, both of which are incorporated herewith in their entirety. This application is related to U.S. Patent Application No. ______, Attorney Docket No. 36524.8001 .US2 filed Jan. 31, 2002 entitled “Interactive System for Presenting Information in a Designated Setting”.

### TECHNICAL FIELD

The following disclosure relates generally to interactive media devices and more particularly to public interactive media display centers.

### BACKGROUND

The dissemination of information to the public takes place through several different avenues. Media, such as television, radio and the Internet are of but a few means by which the public is informed of useful and not so useful information. Venues that are visited by a large number of people can include monitors, kiosks, televisions, or display devices. All of these devices allow the public to remain informed of their surroundings in some fashion and to differing degrees. In areas such as a convention halls or stadiums large displays often project information regarding the events ongoing at the site. In smaller areas such as airports, monitors display information regarding departing and arriving flights. Televisions are also placed throughout terminals providing continuous news, weather, sports and travel related information and kiosks are often found in retail establishments. Through today's media outlets, the public is surrounded by a never ending onslaught of information.

An advertiser, newscaster, or public servant has seemingly an endless number of ways by which he or she can convey information to the public. Gaining the public's receptiveness of this information and offering an attractive means to respond to it in a timely manner remains, however, a challenge. Typically, once a person's attention has been captivated by an advertisement, the individual must recall the contact information provided in the ad and find some means of making a connection. Likewise, a news story that spurs interest in a more defined yet poorly covered subject area places the burden on the individual to find the means to seek out the additional facts. Public information is designed for the public, and while the general public finds such information useful, individuals desire answers to their individual questions and solutions to their individual problems. For example, a weather program that displays a forecast of colder temperatures and rain may beg the question from one onlooker what the driving conditions are in the mountains while another may just desire to know when the sun will return. Such public conveyances of information often result in unanswered questions since the information is necessarily prepared to cover the largest and broadest of audiences.

The resolution of unanswered questions as mentioned above is further complicated by the public's ever shortening attention span. Consumers, individuals conducting business, and people in everyday walks of life make decisions on a minute by minute basis on what will and will not be accomplished. As individuals are subjected to high stress or fast pace environments, the ability of these individuals to process ancillary needs is diminished. People naturally focus on what is important and their attention span for the unimportant is fleeting. Advertisers know that a consumer's interest in a product gained through a television commercial or billboard is short lived. An advertisement for a new car, for example, may capture the interest of a passing businessmen and the businessman may have the intention to contact the dealer for more details. But over the next hour or day the interest fades and the car is forgotten. Retail businesses are constantly seeking ways to gain and capture a consumer's interest so that interest can be realized in a sale.

Accordingly, it can be seen that there is a need for a convergence of traditional means by which information is conveyed to the public and a means by which the public can respond. Furthermore, a need exists for a way to individualize public information, while not destroying the broad and universal nature of an informational service. There is a need therefore, for a device that overcomes the above problems, as well as providing additional benefits.

### BRIEF DESCRIPTION OF THE DRAWINGS

FIG. 1 is an isometric view of one embodiment of an interactive media terminal.

FIG. 2 shows an exploded isometric wireframe view of the interactive media terminal of FIG. 1.

FIG. 3 is a block diagram of one embodiment of a computing environment for use in an interactive media terminal.

FIG. 4 is one embodiment of a system for conveying public information using an interactive media terminal.

FIG. 5 is one embodiment of a distributed computing system for conveying public information using an interactive media terminal.

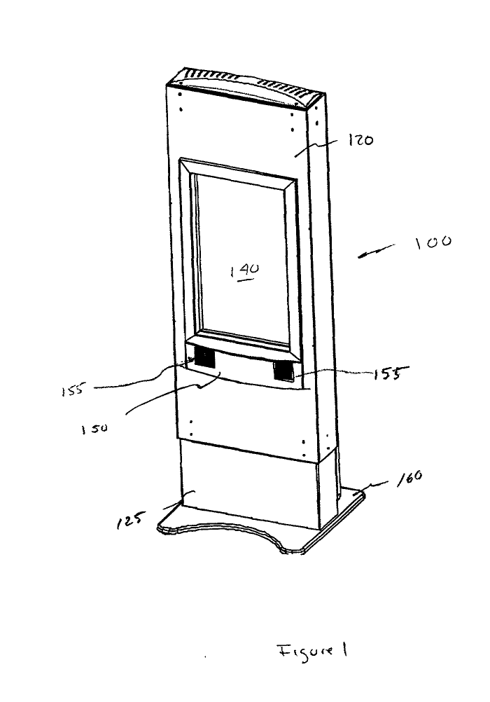

In the drawings, the same reference numbers identify identical or substantially similar elements or acts. To easily identify the discussion of any particular element or act, the most significant digit or digits in a reference number refer to the Figure number in which that element is first introduced (e.g., element 104 is first introduced and discussed with respect to FIG. 1).

### DETAILED DESCRIPTION OF THE ILLUSTRATED EMBODIMENTS

Presented in detail below, is an interactive media terminal for use in the lobbies of buildings or any high traffic open area. The terminal simultaneously presents to viewers information, viewable from varying distances, regarding several different aspects of the environment in which it is located. Furthermore, the terminal can include an interactive capability that allows the closest of viewers to personalize at least one portion of the display as well as input information and interact with a network such as the Internet.

The description that follows describes in detail the components of the media terminal and how each component interacts and is related with each other component. Additional information can be gained by reviewing U.S. Patent Application No. 60/338,848 entitled “Interactive Public Information Display System”, filed on Dec. 7, 2001 which is herein incorporated by reference. Numerous specific details are provided, such as specific display functions, display configurations and interactive capabilities, etc. to provide a thorough understanding of, and enabling description for, embodiments of the invention. One skilled in the relevant art, however, will recognize that the invention can be practiced without one or more of the specific details, or with other components, methods, configurations, etc. In other instances, well-known structures or operations are not shown, or are not described in detail, to avoid obscuring aspects of the invention.

Referring to the drawings in greater detail, the interactive media terminal provides differing displays of information to the public that can be viewed from varying distances and perceived at differing rates. FIG. 1 shows one embodiment of an interactive media terminal 100. The terminal includes an upper housing assembly 120 and a lower chassis assembly 125 that combined are approximately 2-3 meters in height. The terminal is approximately 1 meter wide and 0.25-0.5 meters deep. The media terminal can, however, be fabricated in smaller or larger dimensions depending on the particular application of the terminal and its surrounding environment. Included in the upper housing assembly is a prominent multifunctional display 140 mounted in a portrait orientation. The terminal is fashioned in such a manner that the display screen can be easily observed by both viewers located within physical contact of the terminal and those as far away as approximately 10 meters. The housing and chassis assemblies (120, 125) of the terminal 100 are supported on the floor by a base 160 that is substantially rectangular in shape. In the embodiment shown in FIG. 1, a sound panel 150 is located immediately below the display 140 that includes, in this embodiment, two speakers 155. The terminal of FIG. 1 is free standing, however in alternate embodiments the terminal can be installed in any existing structure to accommodate preexisting architecture or space constraints. Furthermore, in alternative embodiments, the display portion of the terminal can be wall mounted or wall hung with the supporting components located remotely or hidden in the supporting structure. In general, alternatives and alternative embodiments described herein are substantially similar to previously described embodiments, and common elements and functions are identified by the same reference numbers. Only significant differences in construction or operation are described in detail.

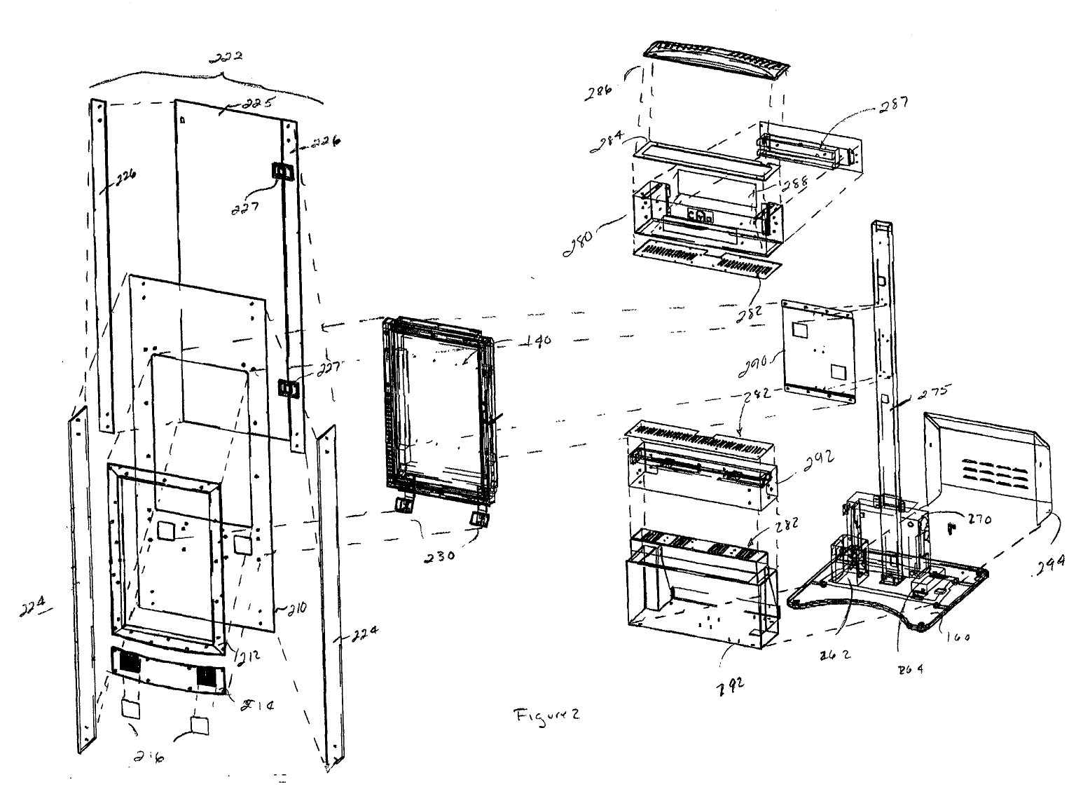

FIG. 2 shows an exploded isometric drawing of the interactive media terminal 100 of FIG. 1. The upper housing assembly 120 of the media terminal 100 includes a front panel 210 and a rear door assembly 222 as well as two side panels 224. In one embodiment the front panel 210, rear door assembly 222, and two side panels 224 are constructed from transparent Plexiglas or similar material. Other material, transparent or opaque, can be used meeting the same structural integrity requirements. The rear door assembly 222 is configured in this embodiment with three components. The center rear access panel 225 is removably coupled to the supporting rear members 226 by a securing device 227 to allow for service access to the internal components of the media terminal. In other embodiments the access panel could have more or less supports or securing devices and the access door could be located on the side or front of the media terminal 100. The front panel 210, in this embodiment, is designed to accommodate a display device 140 and two high fidelity speakers 230. The two speakers 230 are removably coupled to the display device 140 and can be optimized for the environment in which the media terminal 100 is installed. In an alternative embodiment the speakers 230 can be located above the display device 140 to project sound down upon a user or incorporated into the side panels 224 for improved acoustics. Furthermore the number of speakers can be altered to optimize the quality of audio presentation. In this embodiment a subwoofer 262 is located in the base section 160 however in other embodiments the subwoofer 262 may be eliminated. A display bezel 212, a speaker bezel 214 and speaker covers 216 can be attached to the front panel 210 to increase the aesthetic qualities of the media terminal.

The base section 160 includes connectivity for a power supply such as a 110 Volts/AC power source, the subwoofer 262, and an uninterrupted power supply 264 capable of providing power to the terminal in event of a momentary power loss. An uninterrupted power supply 264 can be of various commercially available designs such that upon an interruption of power, sufficient power is available to allow the terminal to shut down using normal operating procedures. In one embodiment of the claimed invention the terminal uses a monitoring and shutdown program that upon an interruption of power, initiates a normal shut down of the system using power supplied by the uninterrupted power supply 264. Rising out of and connected to the base section 160 is a central frame member 275. The central frame member 275 serves as a vertical support for the display device 140 and the upper housing assembly 120. The central frame member 275 is, in one embodiment, constructed from a fiberglass type material. In alternative embodiments other composite, non-conductive materials can be used so as to prevent any amplification, reception or transmission of electromagnetic radiation.

Located in the top section of the media terminal 100 and coupled to the central frame member 275 is a light box assembly 280. The light box assembly 280 includes a lower ventilation panel 282 and an upper frame 282 which is in turn coupled to a ventilated cap 286 affixed to the top of the media terminal 100. The rear of light box assembly is configured to accept a lighting fixture 287 that can illuminate a transparent or translucent panel 288 configured to display a brand, advertisement, or similar image as seen through the front of the light box assembly 280. As shown in FIG. 2, the light box assembly is configured to display the branding symbol of CIVIA™. In an alternative embodiment the terminal can be configured to be a modular design and disassembled into two or more transportable sections to ease movement and installation.

In one embodiment, the central frame member 275 is coupled to a display support frame 290 that is in turn coupled to the back of the display 140. Located below the display support frame 290 is an upper chassis box 292 that is adjacent to the front portion of the lower chassis assembly unit 295. The lower chassis assembly is removably coupled to a rear access door 294 which allows access to a computer 270 and other components contained within the media terminal 100. In one embodiment a printer can be housed within the lower chassis assembly configured to provide output through an access port located on the face of the terminal.

In addition to the power connections and the power supply, the terminal is configured with a communication port for receiving content and transmitting data logs and user interface inputs to a server. The communication port can be configured to operate with an Intranet, the Internet or any other suitable communications network. Communications between the medial terminal and any of the aforementioned networks can be through a direct network connection such as a Ethernet connection, T-1 line, or conventional network access such as a DSL modem or dial up modem. In one embodiment, a modem is located remotely from the media terminal to aid in servicing accessibility.

The computer 270 coupled to the communication port includes at least one processor and at least one storage device. The computer 270 is configured to operate at least one output display device and receive inputs from user interfaces such as a keyboard or mouse or any other user interface device. In one embodiment the computer is configured to operate with a removable keyboard or other user interface devices such as mice, joysticks, touch pads, etc. The computer 270 is of conventional design and in one embodiment comprises a Pentium™ 4 processor operating at 1.4 gh with 512 mb of RAM and a 20 gb hard drive. The computer 270 can also be of a distributed nature.

The computer 270 in one embodiment is located in the lower section of the media terminal, however other locations facilitating economy of space and operational necessities can be used. Furthermore, the computer 270 can be remotely located if warranted by the installation and operation conditions. Located immediately above the base section and approximately 1.1 meters from the floor is the sound panel. The sound panel as previously described includes various speaker and/or microphone configurations providing audio capability to the media terminal. These speakers work in conjunction with the user interfaces provided on the display, the computer and the subwoofer to provide a realistic and effective audio presence for the user. The actual type, number, and location of the speakers within the sound panel and even the location of the sound panel itself can be varied. The computer 270 is capable of executing coded instructions that direct the operation of the media terminal. These instructions include the operation of the display device 140, located prominently on the face of the media terminal, the speakers, user interface, and other associated components of the terminal 100. The computer 270 also translates and presents content received via the communication ports and correlates user inputs regarding the display of this content from an infrared touch sensitive screen.

The display device 140 is coupled among the computer 270 and storage devices and set in a position to be easily viewed by individuals in the vicinity of the terminal. In one embodiment the display device 140 is a 480×848 plasma screen connected directly to a Matrox™ video card. The display device is approximately 1.07 meters in height and 0.61 meters in width and orientated vertically. The presentations on the display are rotated from a landscape orientation to a portrait orientation using, in one embodiment, a video card with software entitled Pivot™. In other embodiments smaller or larger displays may be used with or without Pivot™ software. Since the display device is approximately 1.5 meters above the floor, it is easily accessible to an individual in front of the display 140 yet still allowing the upper portions of the display 140 to be seen from a distance. The height of the display 140 can be varied to increase the visibility of the content and be augmented with a separate user interface if necessary. Furthermore the position of the user interface, be it separate or incorporated through the display, can be adjusted to meet the requirements of the American Disability Act to ensure the terminal is accessible to disabled users. Regardless of the position, the user interface, be it through a touch sensitive screen or a separate device, is placed so as to be easily accessible by an individual located in the terminal's 100 immediate vicinity. The display device can be instructed to display content on portions of the screen independently. Furthermore, a display positioned to show multiple forms of content can be altered to have one piece of content utilize the entire display. In one embodiment the display devices is sectioned into at least three portions typically operating independently. In other embodiments, more or fewer portions of the display device can be segmented for independent programming.

Associated with the display device is a touch sensitive screen or similar device that can correlate a user's input via the display device to the computer. As previously mentioned, other user input devices such as a touchpad or keyboard can be configured to interact with the terminal. In one embodiment an infrared frame is placed around the display device that projects a field in a planar orientation of infrared transmitters and detectors. As an individual reaches to touch the screen, the location of where the field of infrared light is broken is correlated through the computer to the current display. For example if a button is depicted on the screen at a certain location, a break in the infrared plane at the same location would be interpreted as a user input to click that button. The touch sensitive screen is, therefore, overlaid upon the display device such that it can act as a user interface with regard to the content being displayed. The touch sensitive screen can be infrared as indicated in this embodiment or any other system known to those skilled in the relevant art that can detect user inputs and coupled among the display device 140 and computer 270. To protect the display device 140, a protective shield can be placed between the touch sensitive screen and the display device. This shield can be fabricated of bullet resistant glass or Plexiglas to provide a vandal resistant surface while not impeding with the visual characteristics of the display.

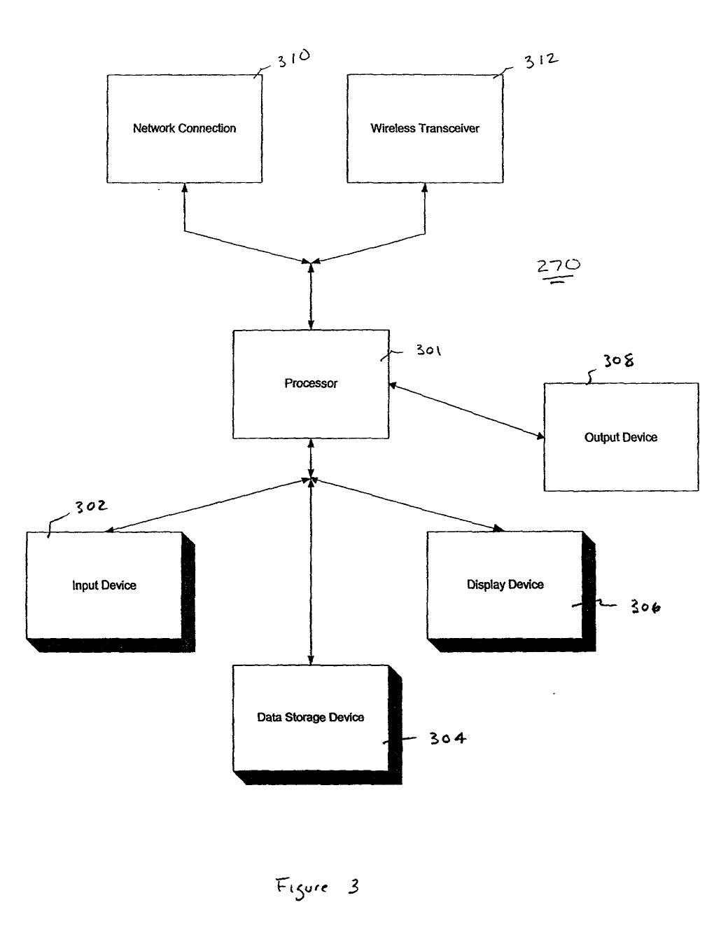

FIG. 3 and the following discussion provides a brief, general description of a suitable computing environment 300 in which aspects of the invention can be implemented. Unless described otherwise below, the construction and operation of the various blocks shown in FIG. 3 are of conventional design. Any modifications necessary to the blocks in FIG. 3 (or other embodiments) can be readily made by one skilled in the relevant art based on the detailed description provided herein. Although not required, aspects and embodiments of the invention will be described in the general context of computer-executable instructions, such as routines executed by a general purpose computer, e.g., a server or personal computer. Those skilled in the relevant art will appreciate that the invention can operate with other computer system configurations, including Internet appliances, multi-processor systems, microprocessor-based or programmable consumer electronics, network PCs, minicomputers, mainframe computers and the like. The invention can also be embodied in a special purpose computer or data processor that is specifically programmed, configured or constructed to perform one or more of the computer-executable instructions. Indeed, the term “computer”, as used generally herein, refers to any of the above devices, as well as any data processor.

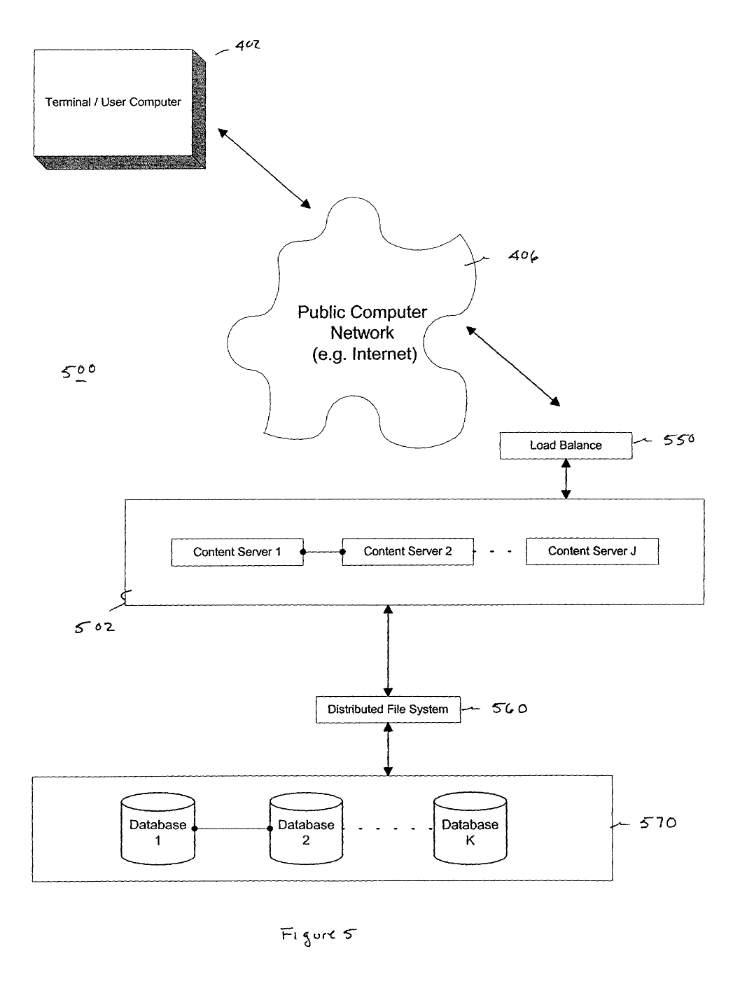

As mentioned, the invention can utilize a distributed computing environment where tasks or modules are performed by remote processing devices linked through a communications network, such as a Local Area Network (“LAN”), Wide Area Network (“WAN”) or the Internet. In a distributed computing environment, program modules or sub-routines may be located in both local and remote memory storage devices. For example, content displayed on the display device 140, can be stored at a remote location or at the terminal. Furthermore, a remote server can be configured to control the display device 140 and the manner the content is presented. The remote server can operate to control two or more terminals operating in concert with each other as well. Aspects of the invention described herein may be stored or distributed on computer-readable media, including magnetic and optically readable and removable computer discs, stored as firmware in chips (e.g., EEPROM chips), as well as distributed electronically over the Internet or over other networks (including wireless networks). Such a distributed environment is shown in FIG. 5. Those skilled in the relevant art will recognize that portions of the invention can reside on a server computer, while corresponding portions can reside on a client computer. Data structures and transmission of data particular to aspects of the invention are also encompassed within the scope of the invention.

Referring again to FIG. 3, one embodiment of the media terminal 100 employs a computer 270, such as a personal or portable computer, having one or more processors 301 coupled to one or more user input devices 302 and data storage devices 304. The computer is also coupled to at least one output device such as a display device 306 and can be coupled to one or more optional additional output devices 308. The computer may also be coupled to external computers via an optional network connection 310, a wireless transceiver 312, or both.

The input devices 302 may include a keyboard, a touchpad, a pointing device such as a mouse, and/or a touch sensitive screen. Other input devices are possible such as a microphone, joystick, pen, game pad, scanner, and the like. The data storage devices 304 may include any type of computer-readable media that can store data accessible by the computer 270, such as magnetic hard and floppy disk drives, optical disk drives, magnetic cassettes, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet (not shown in FIG. 3).

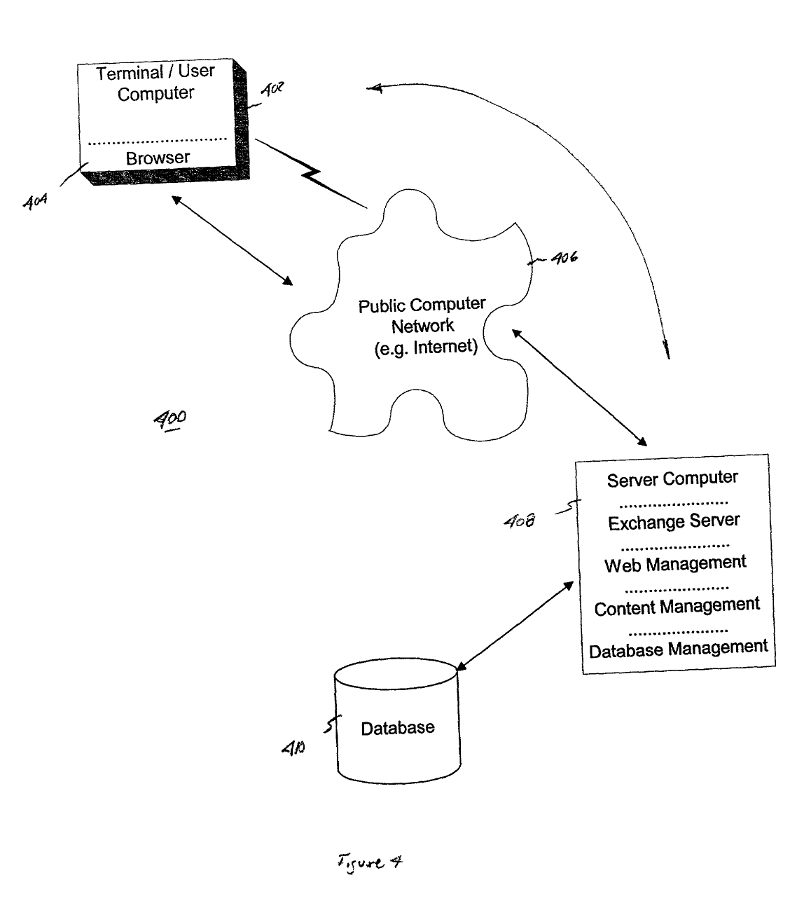

Aspects of the invention can be practiced in a variety of computing environments. For example, referring to FIG. 4, one or more computers 402 in a system 400 are shown, each of which includes a browser program module 404. The computers associated with the terminal 100, or the user computers as they are referred to in FIG. 4, permit the media terminal 100 to access and exchange data with the Internet 406. This access to the Internet includes gaining access to web sites within the World Wide Web as well as the other capabilities known to one in the art. In an alternative embodiment, the terminal 100 can access a server computer directly via a dedicated or internal network. The server can then communicate with the Internet and convey content to the terminal 100 as required. The user computers may include one or more central processing units or other logic-processing circuitry, memory, input devices (e.g., keyboards and pointing devices), output devices (e.g., display devices and printers), and storage devices (e.g., magnetic, fixed and floppy disk drives, and optical disk drives), all well known but not shown in FIG. 4. As previously indicated, in one embodiment, the input device of the media terminal 100 can be a touch sensitive screen while the output device can be a multifunctional plasma display. In addition to this display the speakers that were previously described, can also be output devices as can a printer or transceiver to wirelessly exchange data.

User computers 402 may also include other program modules such as an operating system, one or more application programs (e.g., word processing or spread sheet applications), and the like. Furthermore, user computers 402 can include wireless computers, such as mobile phones, personal digital assistants (PDA's), palm-top computers, etc., which communicate with the Internet 406 via a wireless link. In one embodiment, users can communicate with the terminal via a mobile phone, PDA or mobile computer.

A server computer(s) 408, coupled to the Internet or World Wide Web (“Web”) 406, can perform much or all of the functions for receiving, routing and storing of electronic messages, such as web pages and electronic messages such as email messages. While the Internet is shown, a private network, such as an intranet may likewise be used herein. Communication with such networks can be accomplished through a variety for mediums. In one embodiment a modem or other communication device is used to exchange data between the Exchange server and the computer server such as a network interface card in conjunction with a DSL modem card. Alternative embodiments can include a DSL card that includes modem and router capabilities as well as cards for cable TV or NTSC analog TV. In yet another alternative embodiment a TV tuner can be coupled to the processor to enable the display of TV content. Typically, a high speed data line, such as but not limited to a DSL line or coaxial cable, can be used, however standard phone lines and other communication lines known to one in the art can also be used. Also a database 410, coupled to the server computer 408, can store much of the web pages and content exchanged between the user computers 402. The server computer 408, including the database 410, may employ security measures to inhibit malicious attacks on the system, and to preserve integrity of the messages and data stored therein (e.g., firewall systems, secure socket layers (SSL) password protection schemes, encryption, and the like). In one embodiment, the content being displayed by a terminal can be transmitted to a server computer and displayed at a remote location. By monitoring the displayed content at a central location, a manager can determine the status of several terminals from a single location. In an alternative embodiment, data such as display temperature, communication status and other parameters can be transmitted to a central monitoring location to ensure that the terminal is operating normally. In still another embodiment a PC Watchdog™ card can be added to the computer 270. The Watchdog™ card monitors both hardware and software functionality of the computer and reboots the computer when it detects hardware or software malfunctions.

Referring to FIG. 5, an alternative embodiment to the computer system 400 is shown as a distributed system 500. The distributed system 500 is substantially similar to the system 400, but includes more than one content server computer (shown as server computers 1, 2, . . . J) 502. A load balancing system 550 balances load on the several content server computers. Load balancing is a technique well-known in the art for distributing the processing load between two or more computers, to thereby more efficiently process instructions and route data. Such a load balancer can distribute message and/or content traffic, particularly during peak traffic times.

A distributed file system 560 can be used which couples the content servers to several databases (shown as databases 1, 2 . . . K) 570. A distributed file system is a type of file system in which the file system itself manages and transparently locates pieces of information (e.g., content pages) from remote files or databases and distributed files across the network, such as a LAN. The distributed file system also manages read and write functions to the databases such as the receiving and storing of content to be displayed.

The content that is displayed is controlled by various instructions, subroutines, and display descriptions. In one embodiment the display is partitioned into distinct portions, segments or functional views. This segmentation allows people at a distance to scan headlines, announcements, and promotional messages, while those close to the display use the interactive nature of the terminal to select the news and information in which they are the most interested. The upper most portion in one embodiment can display images with basic environmental conditions such as the current outside weather conditions as well as the time and date. Targeting an audience that possesses a cursory interest in the terminal yet does not feel the need or have the time to pause for further information, this portion of the display may contain news headlines, advertisements and the like.

Another portion of the display device can simultaneously present relevant information as determined by the location of the media terminal. The terminal is therefore capable of presenting several different distinct programming portions simultaneously engaging a wide variety of target audiences. If the media terminal is in a large office building housing primarily financial based companies, this section can provide nonstop financial news thus enticing viewers to view the terminal regularly. Furthermore, the display can change based on the demographics of the location as well as the time of day. The display portion can be designed to entice the viewer to pause for a moment and contemplate the material being presented. As previously indicated, the first, most upper portion, would be targeted at a glancing audience as far award as 10 meters, while this second portion would try to gain the attention of an individual or individuals within 3-5 meters of the terminal who have the desire to gain more in depth information.

A third portion providing nonstop news headlines could be provided to capture the interests of individuals within 1-3 meters. And yet a fourth portion can be designed to allow for direct interaction by the viewer based on the other portions. For example, as a individual is walking by he or she may glance at the terminal to determine what time it is and what are the current weather conditions. Having determined the current time, the individual may glance further down to see an advertisement of interest or a streaming display of the local news or a video clip. Having justified a reason to stop and investigate, the individual can update his or her knowledge of today's headlines by examining the third portion of the display. Having again spurred the onlookers interest, the viewer can gain more information by using the touch sensitive buttons on the screen bringing forward more information in the lower portion of the display while leaving the rest of the screen unaffected. Other onlookers in this embodiment are unaffected by the interaction of the single individual as his or her interaction with the terminal only affects the lower portion. The original displays of time and weather remain unchanged as do the headlines and advertisement or television stream. In an alternative embodiment, the interaction of a user may allow the user to modify the presentation of the content being displayed on the rest of the display. For example, a user, having stopped to seek directions, may retrieve a map of the building or local area. Once displayed, the user may expand the portion of the display presenting the map to enlarge the presentation and enhance the map's detail. The media terminal 100 can also feature local news content, provided by television broadcast stations in each local area, along with advertising, entertainment, and location-specific information. Through automated processes, the terminal 100 can aggregate top news stories, associated images, and video highlights. These stories can then be communicated to the terminals on a regular basis providing users with a convenient free resource for timely news in public spaces or, in an alternative embodiment, be presented real time by the terminal. The terminal can also be configured in an alternative embodiment to provide public service or emergency messages. In situations of distress, such as a fire, the terminal can display evacuation routes or other helpful information. The terminal can also be configured to provide a restricted display, such as building schematics to fire fighters, if the user enters a specific code or touches the screen in an unmarked, unspecified location or manner.

While the system can provide information to a variety of viewers simultaneously, in one embodiment it can also gather information regarding its surrounding. As an individual uses the user interface, the computer can monitor the individual's actions and inputs building a database of information. Furthermore, sensors within the terminal or within the display device itself, such as a proximity sensor, can determine the delayed presence of individuals in front of the terminal within a specific range. In another embodiment a motion detector can determine if the motion of objects near the terminal indicates a person viewing the content being presented. This can be correlated with cameras or other devices that can perform face recognition or similar programs to determine user presence. As more and more people pause to view the display, the computer can correlate the number of individuals present at the device to the advertisement playing or the program being displayed. For example, an advertiser may want to determine over a period of time what advertisement appears to entice onlookers to pause and notice the product. This could be further enhanced by direct feedback from the user interface via the touch sensitive screen. The terminal, therefore, not only provides information to the public but also serves to collect data on the viewing audience. Furthermore, the device could solicit public opinion by providing a public opinion poll that users could answer with the touch screen input. The server could collect the data and provide near real time poll results on each terminal. Indeed, by knowing the location of the terminal by means of a dedicated identifier and the user input, the server can provide geographically segregated poll results to thereby show, e.g., how users in a given neighborhood (associated with terminals in that neighborhood) voted versus users (and associated terminals) in another neighborhood.

At least some of the terminals may include digital still or video cameras configured to provide digital images to the local or server computer to count or read faces of people in front of the terminal. Short-range wireless communications via Bluetooth/IEEE 802.11 or like may be provided via an appropriate transceiver to wirelessly exchange data with a user (e.g. with user's PDA).

While typically the terminals are stationary fixtures, the terminals can be modified to be easily transportable. In such configurations, each terminal can be equipped with a global positioning system so as to transmit its exact location to a control monitoring location. Knowing the exact location of multiple terminals, the content of several terminals can be modified to operate in concert with each other. For example, if several terminals are located in a convention hall or stadium, the location of the terminals could vary as could the content being displayed.

One skilled in the relevant art will appreciate that the concepts of the claimed invention can be used in various environments other than location based or with use of the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. As described herein, the system may be conducted within a single computer environment, rather than a client/server environment. Also, the user computers may comprise any combination of hardware or software that interacts with the server computer, such as television-based systems and various other consumer products through which commercial or noncommercial transactions can be conducted.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” and words of similar import, when used in this application, shall refer to this application as a whole and not to any particular portions of this application.

The elements and acts of the various embodiments described above can be combined to provide further embodiments. All of the above references and U.S. patents and applications are incorporated herein by reference, including U.S. Application No. ______, entitled “Interactive System for Presenting Information in a Designated Setting” filed concurrently herewith and assigned to the same assignee as this invention (Attorney Docket Number 36524.8001.US2). Aspects of the invention can be modified, if necessary, to employ the systems, functions and concepts of the various patents and applications described above to provide yet further embodiments of the invention.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

We claim:

1. An interactive media information terminal for the display and collection of information, comprising:
a housing, wherein the housing includes a frame, a top portion and a bottom portion;
a rectangular display device coupled to the frame, wherein the rectangular display device is orientated in a portrait orientation with respect to the housing;
a processor coupled to the display device, the processor capable of executing computer readable instructions generating two or more distinct views on the display device, the distinct views displaying information capable of being interpreted over a time period unique to each distinct view, and wherein at least one distinct view is a public view for providing public information, while another, simultaneous distinct view is a personal view for personal interactivity with a user;
a protective shield;
a user interface coupled to the processor;
an network connection port coupled to the processor and capable of network communications; and
a data storage device.

2. The device of claim [c1], further comprising a wireless transceiver.

3. The device of claim [c1], wherein the housing is configured to be fixedly located in a public location for simultaneously displaying at least the public and personal views.

4. The device of claim [c1], further comprising:
at least two audio speakers;
a microphone;
a camera;
a computer monitoring card configured to monitor the processor for software or hardware malfunctions wherein upon detection of software or hardware malfunctions the computer card reboots the processor; and
a live video card configured to accept real time Television and video content.

5. The device of claim [c1], wherein the frame possesses non-conductive characteristics.

6. The device of claim [c1], wherein the frame is constructed from nonconductive material.

7. The device of claim [c1], wherein at least one of the distinct views includes meteorological information.

8. The device of claim [c1], wherein at least one of the distinct views includes local area information.

9. The device of claim [c1], wherein the display includes at least four distinct views.

10. The device of claim [c1], wherein at least one of the distinct views is interactive .

11. The device of claim [c1], wherein at least one of the distinct views includes information related to the geographic location of the device.

12. The device of claim [c1], wherein a first of the two or more distinct views includes information that can be perceived over a first time period, and a second of the two or more distinct views includes information that can be perceived over a second time period, the first time period being less than the second time period, the first distinct view positioned above the second distinct view.

13. The device of claim [c1], wherein a first of the two or more distinct views includes information that can be perceived from a first distance, and a second of the two or more distinct views includes information that can be perceived from a second distance, the first distance being greater than the second distance, the first distinct view positioned above the second distinct view.

14. The device of claim [c1], wherein the user interface includes an infrared field projected over the display device such that penetrations of the infrared field are correlated with information displayed on the display device.

15. The device of claim [c1], wherein the user interface includes a microphone coupled to the processor capable of receiving spoken input.

16. The device of claim [c1], wherein the user interface includes a microphone coupled to the processor capable of receiving ambient audio level input.

17. The device of claim [c1], further comprising a global positioning satellite receiver.

18. The device of claim [c1], further comprising a bio-metric reader coupled to the processor, wherein the bio-metric reader is capable of reading information used to identify the user.

19. The device of claim [c1], wherein the housing is modular.

20. The device of claim [c1], wherein the processor is configured to receive user input from the user interface, and in response thereto, retrieve from the data storage device and display in at least one of the two or more distinct views user requested content.

21. The device of claim [c1], wherein the network connection port includes a device capable of connecting to the Internet.

22. The device of claim [c1], further comprising an alternative power supply, the alternative power supply being capable providing adequate power to allow the processor to shut down normally upon failure of primary power to the processor.

23. The device of claim [c1], wherein the processor is retained within the housing.

24. The device of claim [c1], wherein the processor is configured to receive from the communications port, and store in the data storage device, digitally encoded static and video content received from a server, and to instruct the display device to independently display the static and video content in the two or more distinct views.

25. The device of claim [c1], further comprising an output device, wherein the output device includes a printer.

26. The device of claim [c1], further comprising an audio system coupled to the processor.

27. An interactive media information terminal, comprising:
a housing, wherein the housing includes a frame;
a processor retained in the housing capable of executing computer readable instructions generating two or more distinct views, the distinct views providing information capable of being understood at a distance differing for each distinct view;
a rectangular display device capable of displaying the two or more distinct views coupled to the processor, wherein the rectangular display device is mounted to the frame, and wherein a first of the two or more distinct views includes information that can be perceived from a first distance, and a second of the two or more distinct views includes information that can be perceived from a second distance, the first distance being greater than the second distance, the first distinct view positioned above the second distinct view;
a user input device;
a memory device coupled to the processor capable of storing electronic content and computer readable instructions; and
an network connection port coupled to the processor and capable of network communications.

28. The device of claim [c27], wherein the display device is capable of simultaneous display of private content and public content.

29. The device of claim [c27], wherein the user input device includes a touch pad.

30. The device of claim [c27], wherein the user input device includes an infrared field projected over the display device such that penetrations of the infrared field are correlated with information displayed on the display device

31. The device of claim [c27], wherein the frame possesses non-conductive characteristics.

32. The device of claim [c27], wherein the frame is constructed from nonconductive material.

33. The device of claim [c27], further comprising:
at least two audio speakers;
a microphone;
a camera;
a computer monitoring card configured to monitor the processor for software or hardware malfunctions wherein upon detection of software or hardware malfunctions the computer card reboots the processor; and
a live video card configured to accept real time Television and video content.

34. The device of claim [c27], further comprising a bullet resistant shield.

35. The device of claim [c27], further comprising a vandal resistant shield.

36. The device of claim [c27], wherein the user input device is a microphone coupled to the processor capable of receiving spoken commands.

37. The device of claim [c27], further comprising a global positioning satellite receiver.

38. The device of claim [c27], further comprising a bio-metric reader, wherein the bio-metric reader is configured to read biologically identifiable characteristics.

39. The device of claim [c27], further comprising a wireless transceiver.

40. The interactive media information terminal of claim [c27], wherein the processor is configured to receive user input from the user input device, and in response thereto, retrieve from the data storage device and display in at least one of the two or more distinct views user requested content.

41. The interactive media information terminal of claim [c27], further comprising:
an audio system coupled to the processor, the audio system capable of transmitting and receiving audio signals; and
an output device, wherein the output device includes a printer.

42. The interactive media information terminal of claim [c27], wherein the display device is mounted to the in a portrait orientation with respect to the housing.

43. The interactive media information terminal of claim [c27], wherein the display device is mounted to the in a landscape orientation with respect to the housing.

44. A system for displaying information in a public space, the system comprising:
a housing and frame configured to stand at least 2 meters high, and having a bottom portion for resting on a floor and a top portion;
a rectangular display device oriented in a portrait mode and positioned near the top portion of the housing and frame, wherein at least a lower portion of the display device is responsive to a user interface;
a computer coupled to the display device;
a memory device coupled to the computer and configured to store content, including video data;
at least one output device; and
a communications port coupled to the computer and configured receive content from a server and provide data logs to the server.

45. The system of claim [c44], wherein the computer is retained in the housing.

46. The system of claim [c44], wherein the computer is remote to the housing.

47. The system of claim [c44], wherein the output device includes an audio system.

48. The system of claim [c44], wherein the output device includes a printer.

49. The system of claim [c44], wherein the user interface includes an infrared field projected over the display device such that penetrations of the infrared field are correlated by the computer with information displayed on the display device.

50. The system of claim [c44], further comprising a wireless transceiver.

51. The system of claim [c44], wherein the computer is configured to receive from the communications port, and store in the memory device, digitally encoded static and video content received from the server, and to instruct the display device to independently display at least a first, a second and a third portion of the static and video content.

52. The system of claim [c51], wherein the first portion of the content capable of being perceived from a first distance, the second portion of the content is capable of being perceived from a second distance, and the third portion of the content is capable of being perceived from a third distance, the first distance being greater than the second distance and the second distance being greater than the third distance.

53. The system of claim [c52], wherein the first portion is displayed on the display device above the second portion, and the second portion is displayed on the display device above the third portion.

54. The system of claim [c51], wherein
the first portion of content is displayed at an uppermost rectangular portion of the display device for view by people approximately 10 meters from the display device,
the second portion of content is displayed at a middle rectangular portion of the display device for view by people approximately 3 meters from the display device, and
the third portion of content is displayed at a lowermost rectangular portion of the display device for view by a person approximately 1 meter from the display device, and
wherein the computer is configured to receive user input from the user interface, and in response thereto, retrieve from the memory device and display in the third portion user requested content.

55. A system for displaying information in a public space, the system comprising:
a housing and frame configured to stand at least approximately 2 meters high, and having a bottom portion and a top portion;
a rectangular display device oriented in a portrait mode and positioned near the top portion of the housing and mounted to a non-conductive frame;
a computer retained by the housing and coupled to the display device; a user input device coupled to the computer;
a memory device coupled to the computer and configured to store content, including video data; and
a communications port coupled to the computer and configured receive content from a server and provide data to the server.

56. The system of claim [c55], wherein the computer is configured to receive from the communications port, and store in the memory device, digitally encoded static and video content received from the server, and to instruct the display device to independently display two or more portions of content, and wherein the computer is configured to receive user input from the user input device, and in response thereto, retrieve from the memory device and display in one of the two or more portions user requested content.

57. The system of claim [c55], further comprising at least one output device coupled to the computer.
